(19) United States
(12) Patent Application Publication
(10) Pub. No.: US 2023/0380361 A1
(43) Pub. Date: Nov. 30, 2023

(54) Method and device for growing aquatic plants

(71) Applicants: Heinz Plöchinger, Freinberg (AT); Christian Magnus Plöchinger, Freinberg (AT)

(72) Inventors: Heinz Plöchinger, Freinberg (AT); Christian Magnus Plöchinger, Freinberg (AT)

(21) Appl. No.: 17/814,275

(22) Filed: Jul. 22, 2022

(30) Foreign Application Priority Data
May 31, 2022 (DE) 10 2022 113 688.4

(51) Int. Cl. A01G 33/00; F21V 31/00; A01G 7/04

(52) U.S. Cl. CPC A01G 33/00; F21V 31/005; A01G 7/045; F21Y 2115/10

(57) ABSTRACT

A device for growing aquatic plants, in particular filamentous algae or seaweed, has a watertight reservoir (40) suitable for holding water, a plurality of light-emitting elements distributed over the entire volume of the reservoir (40), and an endless conveyor belt (41) with a drive motor (42) for moving the conveyor belt (41) in its endless direction. The conveyor belt is guided through the reservoir by a first deflection mechanism (43) of the device in such a way that at least 50%, preferably 70%, more preferably 90%, more preferably 100% of each of the two surfaces of the conveyor belt (41) receive light from at least one of the lighting elements without being shaded by the conveyor belt (41). The conveyor belt (41) is suitable for anchoring the aquatic plants on it and allowing them to grow while there is water in the reservoir (40).

### CROSS-REFERENCE TO RELATED APPLICATION

This application claims the benefit of German Patent Application No. 10 2022 113 688, filed 31 May 2022, the content of which is incorporated herein by reference in its entirety.

### TECHNICAL FIELD

The disclosure relates to a method and a device for growing aquatic plants.

### BACKGROUND

Climate change, based primarily on high concentrations of carbon dioxide in the atmosphere, is already having dramatic effects. It is irreversible given the current state of affairs in that not enough natural carbon sinks are available to offset even the increase in the amount of CO₂ continuously being released into the atmosphere. Even after achieving climate neutrality, it would still take many decades for the concentration of the harmful gas to naturally decrease.

Technological approaches to the construction of carbon dioxide sinks have so far not been sufficiently successful across the board. High costs and high energy requirements are often the limiting factors.

Carbon dioxide capture through mass planting of well-known land plants is countered by their slow growth.

Unlike terrestrial plants with leaf, stem and root, there is no such division in algae. Under the same conditions, the growth of algae reaches multiple times higher values than that of terrestrial plants.

The benefits of algae are already the focus of many microalgae cultivation projects. Extracting their oil content, however, is laborious.

The present disclosure advantageously combines a number of biological and physical realities to realize scalable, profitable carbon dioxide sinks that simultaneously produce valuable materials. The invention is defined by the subject matter of the claims.

Methods for cultivating microalgae are generally known, both for use as a dietary supplement and for obtaining fuel from the high proportion of oil.

The closed systems required for this are complex and expensive.

For example, US 2009/0148927 discloses reservoirs for growing algae that are emptied at regular intervals. The reservoirs can be illuminated both via a lid and via the floor. The light sources are permanently installed in the walls of the reservoir. A full illumination of the reservoir volume with progressive growth of algae on the bottom and on the surface of the reservoir is not given. US 2009/0148927 is hereby incorporated by reference in its entirety.

US 2018/0223241 discloses a facility for growing microalgae in a two-chamber system, the partition of which is formed by internally illuminated tubes. Here artificial light sources are arranged in a wall of the container. US 2018/0223241 is hereby incorporated by reference in its entirety.

US 2017/0127656 discloses growing filamentous algae on illuminated panels that are suspended vertically above a water reservoir and are wetted with water from there. US 2017/0127656 is hereby incorporated by reference in its entirety.

### SUMMARY

The cultivation of filamentous algae in aerated water reservoirs using wastewater from a sewage treatment plant has been previously studied by the inventors. It is the subject of U.S. Pat. No. 8,685,707, which is hereby incorporated by reference in its entirety. It was found, for example, that a proportion of wastewater of 50% resulted in a relative increase in algae mass of 583%. This means that the yield is greater than with nutrient solution.

The area yield could be up to a factor of 2.5 higher than with flax crops. The study concluded that filamentous algae have a high potential for insulating material production.

However, there was a need for large areas of water per ton of dry algae material produced. This is because when a water surface is horizontal, the algae only grow on the surface. If some layers are on top of each other, the lower layers receive less and less light. A certain thickness of the algae mass thus limits the yield in relation to the water surface.

In the case of the intended use of dried filamentous algae as insulating material in the previous work, the profitability is doubtful because of the large amount of space required.

The supply of insulating material based on petroleum (e.g., polystyrene) and on the basis of stone and glass (mineral wool) is still comparatively cheaper. The disadvantage here, however, is the high energy requirement and the poor ecological balance. For example, the energy requirement for mineral wool production is at least 20 times higher than for renewable insulating materials.

The aim of the present disclosure is to cultivate fast-growing aquatic plants, such as filamentous algae or seaweed, as starting material for novel valuable substances. The surface area required for the systems should be as small as possible in relation to the amount of cultivated algae. The cultivation of large quantities of pure algae should take place in water reservoirs with layered light.

The required systems should be able to be operated with power peaks from photovoltaic or wind systems. The introduction of CO₂, e.g., from exhaust gases, and sewage water as a phosphate and nitrate source should be possible. The need for fresh water should be very low.

A combination of the systems with sewage treatment plants, cement plants, areas under cultivation for vegetables or other soil plants, fish farms, aquacultures, etc. should be possible as an option.

The disclosure is based on the recognition that the light supply for the photosynthesis of the algae is limited by the thickness of the growing algae mass itself. In order to circumvent this limiting factor, suitable LED light is introduced in layers into aerated water reservoirs with nutrient solution, for example by means of light panels. The light panels are at a suitable distance.

An algae conveyor belt (e.g., made of 2 grid-like belts or a transparent film belt with an adhesive surface for algae) is slowly meandered past the light-emitting surfaces via deflection rollers. The number of light panels is selected so that the maximum thickness of the algae mass on the algae conveyor belt is reached at the end of the reservoir. At the end of the reservoir, the algae conveyor belt is pulled out of the water between pressure rollers and guided along a drying section. Optionally, the algae conveyor belt contains inserted electrically conductive elements (e.g., wires) in order to stimulate the growth of algae or grass with electrical voltage or electrical impulses. The electrical field can be built up between the elements (wires) or between the elements (wires) and the electrically conductive nutrient liquid.

The dried algae mass can be wiped off automatically. The endless conveyor belt then runs towards the reservoir again. The transport can take place step by step, i.e., the conveyor belt is moved a certain distance, for example in order to pull algae ready for harvest out of the reservoir and at the same time bring algae into the reservoir for further growth. The conveyor belt then stands still until the algae have grown sufficiently for the next harvest step.

The transport step can be controlled depending on the result of a measurement of the thickness of the algal layer, for example at the end of the transport route in the reservoir. For example, the attenuation of the emission of a light source, such as a photodiode, by the algal layer can be measured and the transport step can be started when the light intensity falls below a limit value. The transport can then continue as long as the light intensity is below the limit value.

The algae production process consists of 3 phases:
a) Cultivation of single-variety suitable filamentous algae.
b) Introduction of the cultivated algae into an algae conveyor belt or affixing of the cultured algae to the transport film.
c) Continuous production of the algal material.

The following detailed description is merely exemplary in nature and is not intended to limit the invention or the application and uses of the invention. Furthermore, there is no intention to be bound by any theory presented in the preceding background or the following detailed description.

### BRIEF DESCRIPTION OF THE DRAWINGS

FIG. 1 shows sections of filamentous algae 11, preferably with a bamboo-like structure, i.e., hollow in the segments, with a diameter D preferably in the micrometer range; the pure breeding material is first produced in the laboratory.

FIG. 2a shows grid-like carrier strips 21a and 22a with cultivated algae 23a from the laboratory and additionally inserted electrically conductive elements (wires) 24a.

FIG. 2b shows a section of an algae transport belt, assembled from carrier belts 21b and 22b with the enclosed algae 23b.

FIG. 3a shows the cross section through a light panel with 2 transparent panels 31a (e.g., glass), the inserted light-emitting diodes (LED) 32a with a suitable wavelength, the waterproof connecting material 33a and the connection cable 34a.

FIG. 3b shows a perspective view of a light panel with 2 transparent panels 31b, inserted light-emitting diodes (LED) 32b, waterproof connecting material 33b and the connection cable 34b.

FIG. 3c shows the top view of an alternative light panel 31c in the form of a transparent light guide panel with an attached LED bar 32c with a suitable wavelength, with reflector strips attached to the light guide panel on the side and bottom 33c and the connecting cable 34c.

FIG. 3d shows a perspective view of a light panel according to FIG. 3c with the light guide panel 31d, the attached LED bar 32d, the reflector strips 33d and the connection cable 34d.

FIG. 4 shows a device for continuous algae production with the following components: waterproof reservoir 40; cover film 40a, permeable to CO₂; algae conveyor belt 41; drive roller 42 with (stepper) motor; deflection rollers 43 in the reservoir (first deflection mechanism); deflection rollers 44 outside the reservoir (second deflection mechanism); pressure rollers 45 in the reservoir; light panels 46 with LEDs, waterproof; feed line 47 for nutrient solution, water with e.g. B. 50% waste water from sewage treatment plant, with valve, controlled by level and pH sensors in the reservoir; supply line 48 for gas (air, CO₂, mixture, etc.) with a valve, controlled by a pH sensor, with a distribution system (not shown), e.g. diffuser hoses; and cutting devices 49 for dried algae mass.

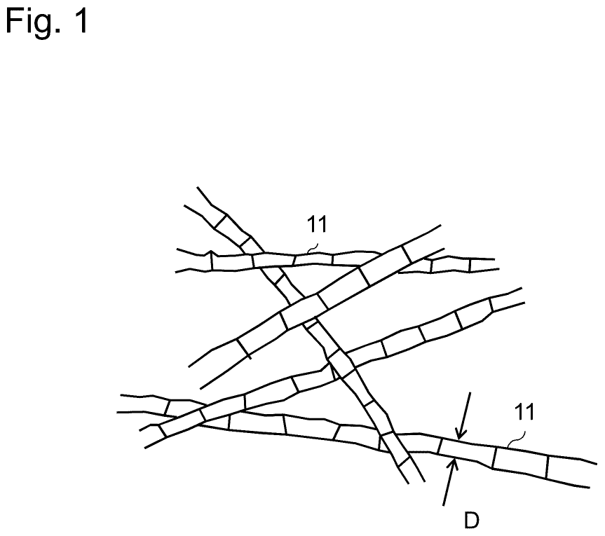

### DETAILED DESCRIPTION

Power peaks from renewable energy sources are temporarily stored in suitable batteries and are used to supply the light panels in a fixed light-dark rhythm. This can be optimized depending on the type of algae and the yield targets.

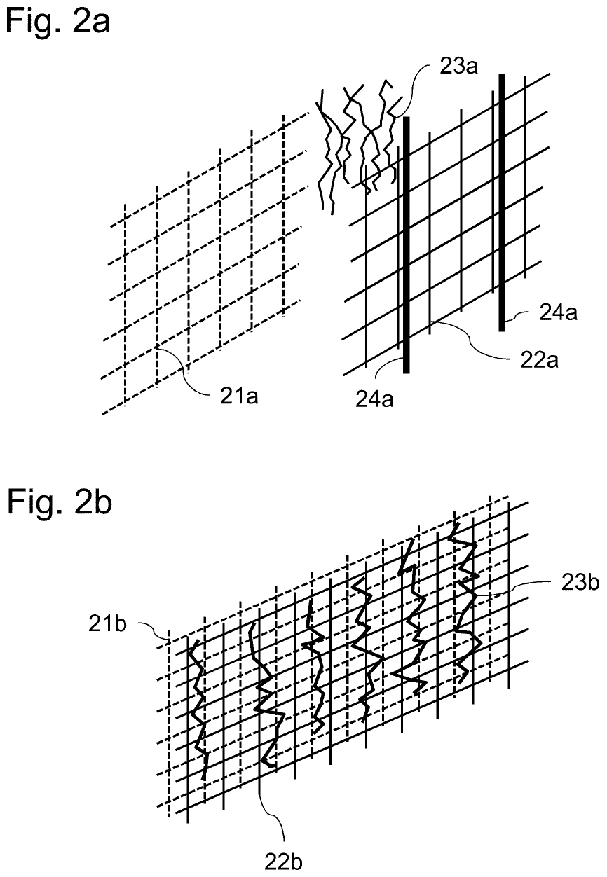

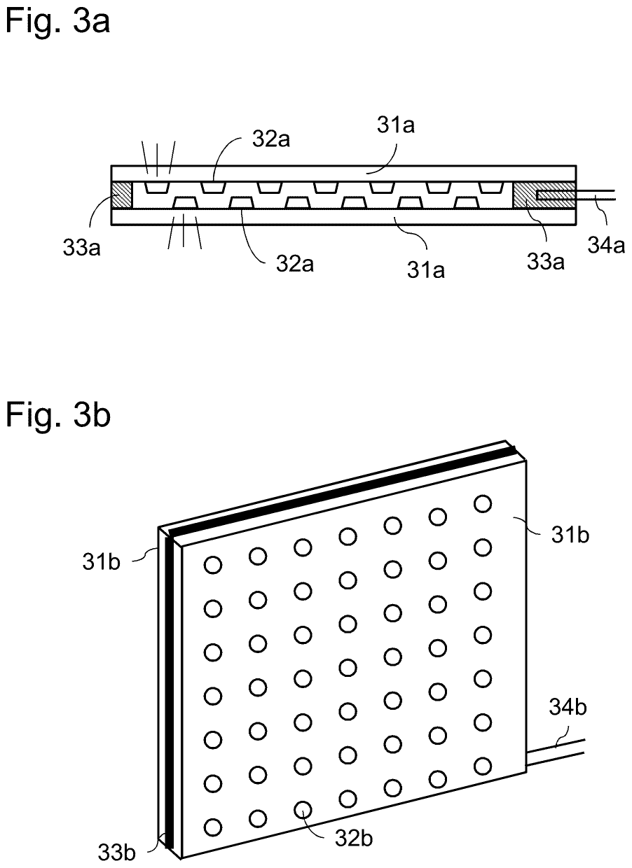

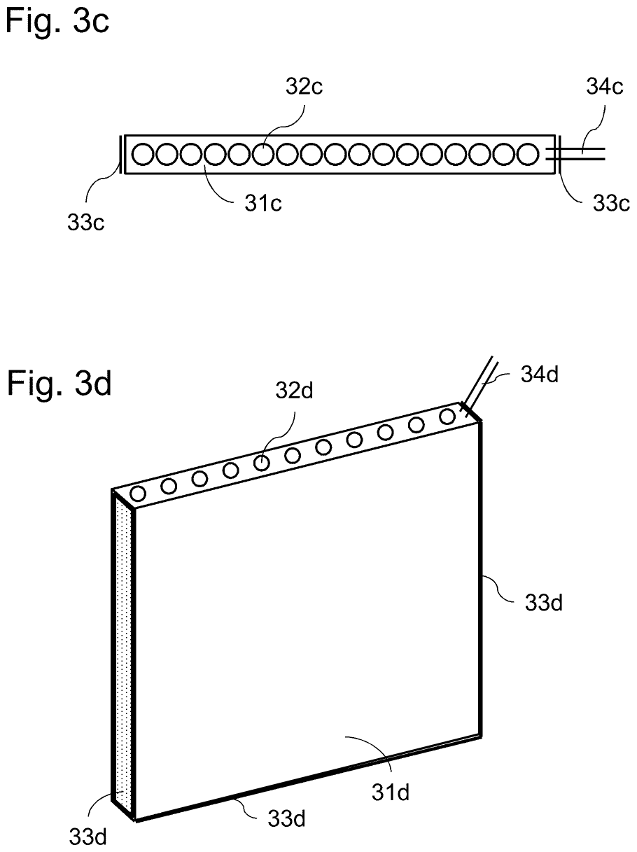

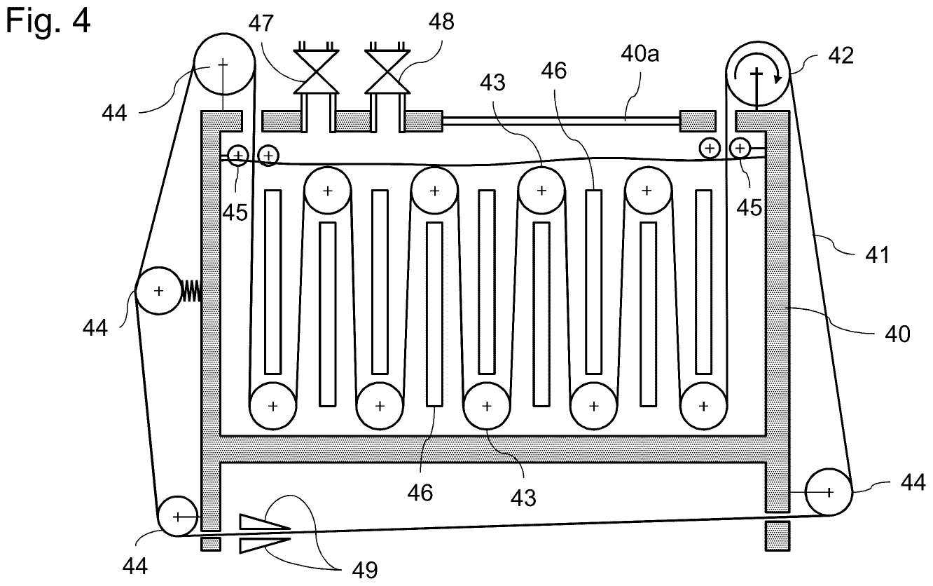

With a good supply of phosphates, nitrates and CO₂, new (daughter) algae grow within a few days from the cultivated mother algae 23a held in the algae conveyor belt 41, see FIG. 2, through the net in the direction of the lighting, i.e., on both sides.

Depending on the desired length of the algae sections to be harvested, the drive roller 42 is slowly moved forward in one direction. A gradual movement is also possible.

Outside the breeding reservoir, the conveyor belt 41 dries with the algae to be harvested in the air, in the sun or by infrared radiators.

At a suitable point, the dried filamentous algae can be separated off near the conveyor belt 41 and thus harvested.

Dry filamentous algae, including the cultivated mother algae in the conveyor belt 41, survive longer periods of dryness unscathed. For species that suffer from dry periods, the conveyor belt 41 can be sprayed with water on the outside.

When re-entering the breeding reservoir, the algae start growing again in the wet medium.

Thus, a continuous process is given as long as energy, CO₂ and nutrients are available in sufficient quantities.

The installation discussed above is also suitable for the growing of other aquatic plants which can attach themselves to the conveyor belt 41.

For example, the root network of seaweed can be anchored in the lattice structure of the conveyor belt 41 in order to allow a layer of seaweed to grow on the conveyor belt 41. The seaweed can remain completely in the reservoir 40 during growth when the conveyor belt 41 is stationary. For harvesting, the conveyor belt 41 is guided past the cutting device 49 over its entire length and is cut off there in such a way that a residue capable of growth remains on the conveyor belt 41. This is done at a sufficient rate to prevent the seaweed root system from drying out.

In a similar way, the device described above can also be adapted to the growing of other aquatic plants.

It also goes without saying that the device shown above can also be designed in a modified form, as long as it achieves its goal of cultivating aquatic plants in a reservoir 40 in the most space-saving form possible. For example, the arrangement and shape of the light panels 46 and the conveyor belt 41 can also be designed differently, as long as the goal is achieved, a sufficiently large area of the conveyor belt 41 (e.g., 50%, 70%, 90%, or 100%) in the reservoir 40 to run under direct irradiation. For example, instead of the light panels 46, any other light elements of a different shape, such as LEDs attached to nets or the like, can also be used. The conveyor belt 41 can then be guided through the reservoir 40 through gaps in the nets in a path that can in principle be freely specified

While the present invention has been described with reference to exemplary embodiments, it will be readily apparent to those skilled in the art that the invention is not limited to the disclosed or illustrated embodiments but, on the contrary, is intended to cover numerous other modifications, substitutions, variations and broad equivalent arrangements that are included within the spirit and scope of the following claims.

1. A device for growing aquatic plants, in particular filamentous algae or seaweed, comprising:
a reservoir (40) suitable for containing water;
a plurality of light-emitting elements distributed over an entire volume of the reservoir (40);
an endless conveyor belt (41); and
a drive motor (42) for moving the conveyor belt (41) in an endless direction,
wherein the conveyor belt is guided through the reservoir by a first deflection mechanism (43) in such a way that at least 50% of each of two surfaces of the conveyor belt (41) receives light from at least one of the light-emitting elements without being shaded by the conveyor belt (41); and
wherein the conveyor belt (41) is suitable for anchoring and growing the aquatic plants thereon while there is water in the reservoir (40).

2. The device according to claim 1, wherein at least 70% of each of the two surfaces of the conveyor belt (41) receives light from the at least one of the light-emitting elements.

3. The device according to claim 1, wherein at least 90% of each of the two surfaces of the conveyor belt (41) receives light from the at least one of the light-emitting elements.

4. The device according to claim 1, further comprising
a second deflection mechanism (44) which guides the conveyor belt (41) around the reservoir (40); and
a cutting device suitable for detaching the aquatic plants from the conveyor belt (41),
wherein a viable remainder of the aquatic plants remains on the conveyor belt (41), which can be transported back into the reservoir (40) for further growth by the conveyor belt (41).

5. The device according to claim 1,
wherein the light-emitting elements are designed in form of flat panels having two flat sides, the flat panels being arranged parallel to one another in the reservoir (40); and
wherein the first deflection mechanism (43) guides the conveyor belt (41) past the two flat sides of each of the light-emitting elements.

6. The device according to claim 1,
wherein at least one of the light-emitting elements comprises two parallel, light-transmitting plates (31a), between which a plurality of LEDs (32a, 32b) are arranged, the LEDs being watertightly enclosed by the light-transmitting plates (31) and a connecting material (33a).

7. The device according to claim 1,
wherein at least one of the light-emitting elements comprises a transparent light guide plate (31d), which is provided with a waterproof LED strip (32d) on at least one narrow side,
wherein the waterproof LED strip (32d) emits light into an interior of the light guide plate, and
wherein a reflective layer is arranged on an opposite narrow side of the at least one light-emitting element.

8. The device according to claim 1,
wherein the light-emitting elements are suitable for adapting a spectrum of light emitted by the light-emitting elements to a growth condition of the aquatic plants.

9. The device according to claim 1, further comprising
a nutrient supply line (47) which is suitable for conducting a nutrient solution via a valve into the reservoir,
wherein the valve is adapted to be controlled based on a water level in the reservoir (40) and based on measured values from pH sensors in the reservoir (40).

10. The device according to claim 1, further comprising
a gas supply line (48) which is suitable for introducing a gas into the water contained in the reservoir (40) via a valve and a distribution system comprising diffusor hoses,
wherein the valve is adapted to be controlled based on measured values from pH sensors in the reservoir (40).

11. The device according to claim 1, further comprising
a battery for storing electrical energy,
wherein the light-emitting elements are suitable for being operated using the electrical energy stored in the battery.

12. The device according to claim 1,
wherein the conveyor belt (41) comprises electrically conductive wires, to which electrical voltage or electrical pulses can be applied.

13. A method for growing filamentous algae, comprising:
providing the device according to claim 1;
introducing the conveyor belt provided with filamentous algae into the reservoir while filled with water;
stimulating growth of the filamentous algae by lighting with the light-emitting elements;
continuously moving the conveyor belt through the reservoir at a speed that allows the filamentous algae on the conveyor belt to grow to a predetermined thickness during a complete passage through the reservoir;
removing the filamentous algae from the reservoir (40);
after removing the filamentous algae from the reservoir (40), separating a part of the filamentous algae from the conveyor belt; and
reintroducing an unseparated part of the filamentous algae into the reservoir for further growth.
